(19) United States
(12) Patent Application Publication
(10) Pub. No.: US 2010/0245067 A1
(43) Pub. Date: Sep. 30, 2010

(54) Method for Operating a Communications Accessory Device

(75) Inventor: Patrick Clauberg, Dortmund (DE)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: novero GmbH, Dusseldorf (DE)

(21) Appl. No.: 12/727,664

(22) Filed: Mar. 19, 2010

(30) Foreign Application Priority Data
Mar. 24, 2009 (EP) 09 004 166. 6

(51) Int. Cl. B60Q 1/00; B60L 1/00

(52) U.S. Cl. 340/438; 307/9.1

(57) ABSTRACT

The present application relates to a communications accessory device, system and method for a motor vehicle having an ignition variable between an “ON”-state and an “OFF”-state, wherein the device and system comprises a permanent power supply line input and an ignition sense line input, wherein the device and system further comprises a control logic directly or indirectly connected to both inputs, and wherein, when not installed, the power supply status of both inputs is “LOW” and, when properly installed in a motor vehicle the power supply status of the permanent power supply line input is permanently “HIGH” and the power supply status of the ignition sense line input is “HIGH” when the ignition of the motor vehicle is “ON” and is “LOW” when the ignition of the motor vehicle is “OFF”. A method of the present application comprises individually detecting the power supply status of the power supply line input and of the ignition sense line input and, in response thereto, at least setting a wrong installation status flag when a power supply status “LOW” of the power supply line input is detected while a power supply status “HIGH” of the ignition sense line input is detected.

### CROSS-REFERENCE TO RELATED APPLICATION

This application claims priority of European Patent Application No. 09 004 166.6, filed Mar. 24, 2009, which application is incorporated herein by reference.

### BACKGROUND

The present application relates to methods of operating a communications accessory device for a motor vehicle and to a communications accessory devices for a motor vehicle.

Upon installation into a motor vehicle, a communications accessory device, e.g. an aftermarket car kit, a car phone, or a car connected personal navigation device, has to be connected at least to a permanent power supply line of the motor vehicle's electrical supply and to an ignition sense line which is connected to the motor vehicle's ignition switch.

Communications accessory devices according to the application may be integrated into a communications device like a mobile phone or may be, primarily, separate from such a communications device. They typically draw power from the vehicles electrical supply and supply power to the communications device.

When the vehicle is not operated the communications accessory device must consume as little power as possible in order not to drain the vehicle's battery excessively. Usually the communications accessory device can switch between an active mode and a sleep mode. In order to be able to switch from the sleep mode when the motor vehicle is not operated into the active mode as soon as the motor vehicle is operated the communications accessory device needs a permanent connection to the vehicle's electrical supply. This is done by a permanent power supply line connected to an input of this communications accessory device.

Usually the permanent power supply line input sees the full voltage of the vehicle's electrical supply system, preferably 12 to 15 V. Usually the ground connection is made through the vehicle's bodywork and not through a separate ground connecting line.

In order to note when operation of the motor vehicle starts the usual communications accessory device is connected to an ignition sense line from the ignition switch of the motor vehicle. As soon as the motor vehicle's ignition is switched on or at least the car key has been turned to a pre-start position the ignition sense line will see the full voltage of the vehicle's electrical supply system. This indicates to the communications accessory device that it is to start its active mode.

Within the framework of the present application, a “motor vehicle” is any motorized vehicle that has an electrical supply system. Primarily it may be a passenger car.

Within the framework of the application, a “communications accessory device” is any kind of professionally installed car device like a car kit, a car phone, a car connected personal navigation device or the like.

Within the framework of the present application, a “control logic” is any kind of electronic control device such as a microprocessor or a group of microprocessors.

Within the framework of the present application the term “HIGH” and “LOW” are relative to each other and can be exchanged for each other. They are used for the usual situation in a mofor vehicle where the full voltage means the status “HIGH” and no voltage or just a residual voltage means the status “LOW”. However, under specific circumstances this may be exactly opposite, too.

The installed communications accessory device is permanently connected to the power supply line but is in its sleep mode when there is no power on the ignition sense line. For easier installation of the communications accessory device adaptor systems are available. The installer often is unaware of incompatibilities of those adaptor systems.

In fact it is possible that the installer might inadvertently connect the ignition sense line input of the communications accessory device to a permanent power supply line and the permanent power supply line input to the ignition sense line. In this situation the communications accessory device and its associated communications device will see that the ignition of the motor vehicle is permanently on, which will then lead to undesirable drainage of the motor vehicle's battery.

Moreover, improper installation will cause the communications accessory device to fail in its proper start-up and shut-down procedures, etc., so it might be impossible to properly handle a language selection or other start-up function.

In the prior art reference WO-A-00/46930, the correctness of an ignition sense line installation is checked by a combination of a wrong installation status flag and a suitable timer. If the timer expires before a second signal is received over the ignition sense line, the wrong installation status flag is set to indicate an improper installation of the ignition sense line. The installed timer will usually be set to about 12 hrs. This long timing is necessary to avoid an erroneous setting of the wrong installation status flag. However, there is still a slight possibility that the installed timer may expire even when the ignition sense line is properly installed, e.g. when the motor vehicle is a long-haul truck that operates for more then 12 hrs. continuously.

A further downside of the prior art method is that proper ignition sense line installation is not checked at the very beginning, namely immediately after installation of the communications accessory device and while the motor vehicle is still at the repair shop.

So there is a need for a method of operating a communications accessory device in a motor vehicle to determine immediately upon its installation whether the ignition sense line has been correctly installed. Likewise, the same problem is presented for a communications accessory device as such.

### SUMMARY

A method of the present application includes individually detecting the power supply status of the power supply line input and of the ignition sense line input and, in response thereto, at least setting a wrong installation status flag when a power supply status “LOW” of the power supply line input is detected while a power supply status “HIGH” of the ignition sense line input is detected.

Following a method according to the present application, the detection of an improper installation is done based on the expected voltage levels at the two inputs. The following table shows what is to be expected.

| Power line | Ignition line | Interpretation |
|---|---|---|
| LOW | LOW | Device not installed |
| HIGH | LOW | Normal, ignition OFF |
| LOW | HIGH | Installation wrong |
| HIGH | HIGH | Normal, ignition ON |

This simple system has the effect that the person installing the communications accessory device in a motor vehicle will be immediately alerted to a wrong installation of the ignition sense line. No harm is done, the installation is nearly foolproof.

In an embodiment of the present application, the hardware provides for a visual indicator and/or an audio indicator and a method according to the application further comprises operating the visual indicator and/or the audio indicator upon setting of the wrong installation status flag.

Finally, in an advanced version of a method of the present application it is possible to provide the communications accessory device with an inverter switch or to have a separate inverter switch connected to the device at the inputs so that the control logic will operate the inverter switch to exchange the permanent power supply line input and the ignition sense line input in response to the wrong installation status flag being set.

The term “status flag” covers all kinds of indications or signals, either short, limited signals or permanent signals like a specific voltage level on a particular line.

A communications accessory device according to the present application implements the method steps in its control logic and associated hardware.

### BRIEF DESCRIPTION OF THE DRAWING

The drawing is a block diagram illustrating an embodiment of the present application.

### DETAILED DESCRIPTION OF THE DRAWING

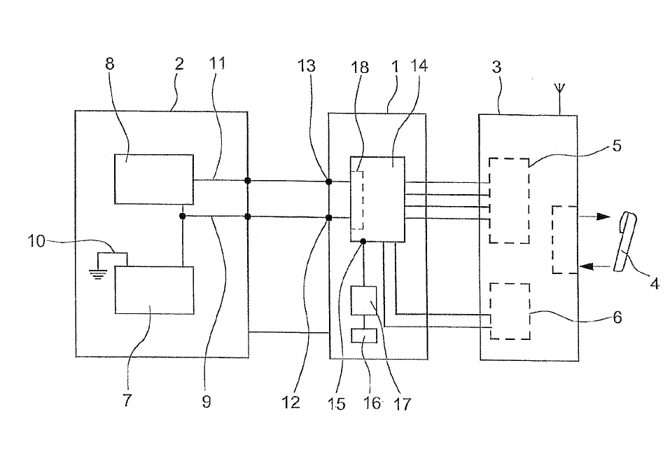

Hereafter the method according to the present application and the corresponding communications accessory device is explained with reference to the drawing. In the drawing the sole FIGURE (FIG. 1) shows a simplified block diagram of a communications accessory device 1 connected between the electrical supply circuit of a motor vehicle 2 on the one hand and a wireless communications device 3 like a mobile phone on the other hand is shown.

In the drawing, a communications accessory device 1 employing methods of the present application operates with a multi-state power management system to control its power consumption and the power consumption and operating status of an attached wireless communications device 3. Those devices are operating in a motor vehicle 2 like a passenger car.

In the present embodiment a mobile phone is the illustrative example of the communications device 3, here with a headset 4 connected to the mobile phone 3 via a Bluetooth wireless connection.

It is possible to integrate the communications accessory device 1 with the communications device 3, e.g. for a car connected personal navigation device etc. In the present embodiment, however, the communications accessory device 1 provides a docking station for the communications device 3. Upon docking the communications device 3 to the communications accessory device 1 the processor 5 of the communications device 3 is connected to the communications accessory device 1 and the power supply 6 of the communications device 3 is also connected to the communications accessory device 1.

Just for purposes of better understanding the present application, the motor vehicle 2 is displayed with its components relevant to the disclosure only, namely a battery 7 and an ignition 8 represented by an ignition switch. A power supply line 9 is indicated as well as a ground line 10 represented by a connection of the battery 7 to the bodywork of the motor vehicle 2. A further line indicates the ground-connection of the motor vehicle 2 with the communications accessory device 1.

Of course, the motor vehicle 2 further has other components like an engine, an alternator etc. and of course the electrical supply system supplying electrical energy to all the components in the motor vehicle 2.

The ignition 8 causes the engine of the motor vehicle 2 to start and stop and is typically controlled by the user via a multi-position key switch, the ignition switch. For purposes of illustrating this invention the ignition 8 will be considered “OFF” when the key switch is in the off and start positions and will be considered “ON” in all other positions of the key switch, typically the engine run position and the preliminary accessory on position.

From the ignition 8 or the key switch of the ignition 8 an ignition sense line 11 extends to the communications accessory device 1. The power supply line 9 is connected to the permanent power supply line input 12 of the communications accessory device 1 while the ignition sense line 11 is connected to the ignition sense line input 13 of the communications accessory device 1.

The communications accessory device 1 further comprises a control logic 14 here indicated by a single microprocessor which of course may comprise other components also and may comprise more then one microprocessor. The control logic 14 is connected to both inputs 12, 13.

When not installed the power supply status 6 of both inputs is “LOW” and, when properly installed in a motor vehicle 2, the power supply status 6 of the permanent power supply line input 12 is permanently “HIGH”. The power supply status of the ignition sense line input 13 is “HIGH” when the ignition of the motor vehicle 2 is “ON” and is “LOW” when the ignition 8 of the motor vehicle 2 is “OFF”.

One aspect of the present application is that the control logic 14 is constructed and/or programmed to detect the power supply status 6 of the power supply line input 9 and of the ignition sense line input 11 and, in response thereto, sets at least a wrong installation status flag 15 when a power supply status 6 “LOW” of the power supply line input 9 is detected while a power supply status 6 “HIGH” of the ignition sense line input 13 is detected. The wrong installation status flag 15 here is indicated as an output line of the control logic 14. It switches from “LOW” to “HIGH” when the control logic 14 detects a wrong installation of the ignition sense line 11, namely attachment of the ignition sense line 11 to the permanent power supply line input 12 and the power supply line 9 to the ignition sense line input 13.

In the present application, erroneous installation is not only detected and the wrong installation status flag 15 set (which might be evaluated electronically), but in addition the device 1 is provided with a visual indicator 16 and an audio indicator 17 so that upon setting of the wrong installation status flag 15 the visual indicator 16 and the audio indicator 17 are operated. The user is alerted by those signal means that the ignition sense line 11 was wrongly installed. Such mistake can be rectified immediately.

The drawing further illustrates an inverter switch 18 which may be used in an additional embodiment of the communications accessory device 1. Such inverter switch 18 is operating the inputs 12, 13 in a way to exchange or switch over those inputs upon the wrong installation status flag 15 being set. The wrong installation is automatically rectified in this embodiment of the communications accessory device 1.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent elements with insubstantial differences form the literal languages of the claims.

1. A method off operating a communications accessory device for a motor vehicle, the motor vehicle having an ignition variable between an ON-state and an OFF-state, the method comprising:
individually detecting a power supply status of a power supply line input and of an ignition sense line input of the device and, in response thereto,
setting at least a wrong installation status flag when a power supply status LOW of the power supply line input is detected while a power supply status HIGH of the ignition sense line input is detected, wherein the device includes a control logic coupled with both inputs, wherein the control logic effectuates the detecting and setting steps.

2. The method of claim 1, wherein the device includes a visual indicator, and the method further comprises operating the visual indicator upon setting of the wrong installation status flag.

3. The method of claim 1,
wherein the device includes an input inverter switch, and
the method further comprises exchanging the permanent power supply line input and the ignition sense line input upon setting of the wrong installation status flag.

4. A communications accessory device for a motor vehicle having an ignition variable between an ON-state and an OFF-state, wherein the device comprises:
a permanent power supply line input,
an ignition sense line input; and
a control logic coupled with both inputs; and
wherein the control logic detects a power supply status of the power supply line input and of the ignition sense line input and, in response thereto, sets a wrong installation status flag at least when a power supply status LOW of the power supply line input is detected while a power supply status HIGH of the ignition sense line input is detected.

5. The communications accessory device according to claim 4, further comprising a visual indicator, wherein the visual indicator is operated upon the wrong installation status flag being set.

6. The communications accessory device according to claim 4, further comprising an input inverter switch operative to exchange the permanent power supply line input and the ignition sense line input upon the wrong installation status flag being set.

7. (canceled)

8. (canceled)

9. The method of claim 1, wherein when not installed, the power supply status of both inputs is LOW and, when properly installed in a motor vehicle the power supply status of the permanent power supply line input is permanently HIGH and the power supply status of the ignition sense line input is HIGH when the ignition of the motor vehicle is ON and is LOW when the ignition of the motor vehicle is OFF.

10. The method of claim 1, wherein the device includes an audio indicator, and the method further comprises operating the audio indicator upon setting of the wrong installation flag status.

11. The communications accessory device according to claim 4, wherein when not installed, the power supply status of both inputs is LOW and, when properly installed in a motor vehicle the power supply status of the permanent power supply line input is permanently HIGH and the power supply status of the ignition sense line is HIGH when the ignition of the motor vehicle is “ON” and is LOW when the ignition of the motor vehicle is OFF.

12. The communications accessory device according to claim 4, further comprising an audio indicator, wherein the audio indicator is operated upon the wrong installation status flag being set.

13. A communications accessory system wherein the system comprises:
an electrical supply circuit in a motor vehicle;
a communications accessory device including:
a permanent power supply line input from the electrical supply circuit;
an ignition sense line input from the electrical supply circuit;
a control logic in the communications accessory device coupled with the permanent power supply line and the ignition sense line, wherein the control logic detects a power supply status of the power supply line input and of the ignition sense line input and, in response thereto, sets a wrong installation status flag at least when a power supply status LOW of the power supply line input is detected while a power supply status HIGH of the ignition sense line input is detected; and
an indicator, wherein the indicator is activated when the wrong installation status flag is set.

14. The communications accessory system according to claim 13, wherein the indicator is a visual indicator.

15. the communication accessory system of claim 13, wherein the indicator is an audio indicator.

16. The communications accessory system according to claim 13, further comprising an input inverter switch operative to automatically rectify the wrong installation status flag by exchanging the permanent power supply line input and the ignition sense line input upon the wrong installation status flag being set.

17. The communications accessory system of claim 13, wherein when not installed, the power supply status of both inputs is LOW and, when properly installed in a motor vehicle the power supply status of the permanent power supply line input is permanently HIGH and the power supply status of the ignition sense line input is HIGH when the ignition of the motor vehicle is ON and is LOW when the ignition of the motor vehicle is OFF.
